(19) United States
(12) Patent Application Publication
(10) Pub. No.: US 2019/0153853 A1
(43) Pub. Date: May 23, 2019

(54) FLOAT ARRANGEMENT AND SENSOR ARRANGEMENT FOR A PUMP JACK-TYPE WELL

(71) Applicant: CNX Gas Company LLC, Canonsburg, PA (US)

(72) Inventors: Richard Michael Wright, Clune, PA (US); Thomas C. Tonkins, Pittsburgh, PA (US); Joseph M. Fink, Washington, PA (US)

(73) Assignee: CNX Gas Company LLC, Canonsburg, PA (US)

(21) Appl. No.: 16/300,231

(22) PCT Filed: May 8, 2017
(86) PCT No.: PCT/US17/31513

§ 371 Date: Nov. 9, 2018

Related U.S. Application Data
(60) Provisional application No. 62/333,609, filed on May 9, 2016.

(51) Int. Cl. E21B 47/04; E21B 43/12; G01F 23/76

(52) U.S. Cl. CPC E21B 47/042; G01F 23/76; E21B 43/127

(57) ABSTRACT

This invention provides for an apparatus that controls a liquid level down-hole of a hydrocarbon producing well by physically monitoring the liquid level down-hole having a down-hole liquid level measurer and a signal device connected to the liquid level measurer that causes a pump to adjust its current liquid output based on the liquid level down-hole as measured by the down-hole liquid level measurer.

### CROSS REFERENCE TO RELATED APPLICATION

This application claims benefit to U.S. Provisional Application Ser. No. 62/333,609, filed May 9, 2016, which is hereby incorporated by reference in its entirety.

### BACKGROUND OF THE INVENTION

### Field of the Invention

The present invention relates generally to systems, assemblies, and arrangements for use in connection with a pump jack-type well with an outer well casing and production fluid tubing, and in particular to a float and/or sensor arrangement or assembly for a pump jack-type well, such as a hydrocarbon well.

### Description of the Related Art

It is recognized that most gas and oil wells, e.g., >80%, use artificial lift to pump fluids to the surface, such as pump jacks, progressive cavity pumps, and electrical submersible pumps. The most commonly-used systems in the United States include or are in the form of pump jacks.

Accordingly, there is a need in the art for a float assembly and/or a sensor assembly that are useful in connection with a pump jack-type well where there is an outer well casing and inner production tubing.

### SUMMARY OF THE INVENTION

Generally, provided are a float arrangement (or assembly) and/or a sensor arrangement (or assembly) mounted on a “pup” section of stainless steel production tubing for use in connection with a pump jack-type well. Preferably, provided are a float arrangement (or assembly) and/or a sensor arrangement (or assembly) for use in or in connection with a fluid control system used in a pump jack-type well.

In one preferred and non-limiting embodiment or aspect, the float arrangement (or assembly) and/or the sensor arrangement (or assembly) are installed on or in connection with a 4.5″ outside diameter casing with a fluid riser tubing “production tubing” having a 2⅜″ outside diameter. The system can also operate with larger diameter production tubing such as 2⅞″ installed in a larger well casing, such as 7″ well casing. This tubing is used to pump the fluid collected from the well “rat hole” to the surface. The pumped fluid may include water, brine, and/or oil, and will typically contain hydrocarbons.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various Figs. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise. Preferred features will be elucidated in the claims and in the specific description of the embodiments that follow. It will be readily appreciated that preferred features of certain aspects or embodiments could be usefully incorporated in other described embodiments even if not specifically described in those terms herein.

### BRIEF DESCRIPTION OF THE DRAWINGS AND APPENDICES

FIG. 1 is an isometric view of an apparatus for that controls a liquid level down-hole of a hydrocarbon producing well by monitoring the liquid level down-hole;

FIG. 2 is a top view of an apparatus for that controls a liquid level down-hole of a hydrocarbon producing well by monitoring the liquid level down-hole;

FIG. 3 is a section view along line 3-3 of FIG. 2 of an apparatus for that controls a liquid level down-hole of a hydrocarbon producing well by monitoring the liquid level down-hole;

FIG. 4 is an isometric view of a float;

FIG. 5 is a section of along lines 5-5 of FIG. 2 of an apparatus for that controls a liquid level down-hole of a hydrocarbon producing well by monitoring the liquid level down-hole; and

FIG. 6 is a side view of an apparatus for that controls a liquid level down-hole of a hydrocarbon producing well by monitoring the liquid level down-hole without a housing or a shroud.

### DETAILED DESCRIPTION OF THE INVENTION

For purposes of the description hereinafter, the terms “end”, “upper”, “lower”, “right”, “left”, “vertical”, “horizontal”, “top”, “bottom”, “lateral”, “longitudinal” and derivatives thereof shall relate to the invention as it is oriented in the drawing Figs. However, it is to be understood that the invention may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

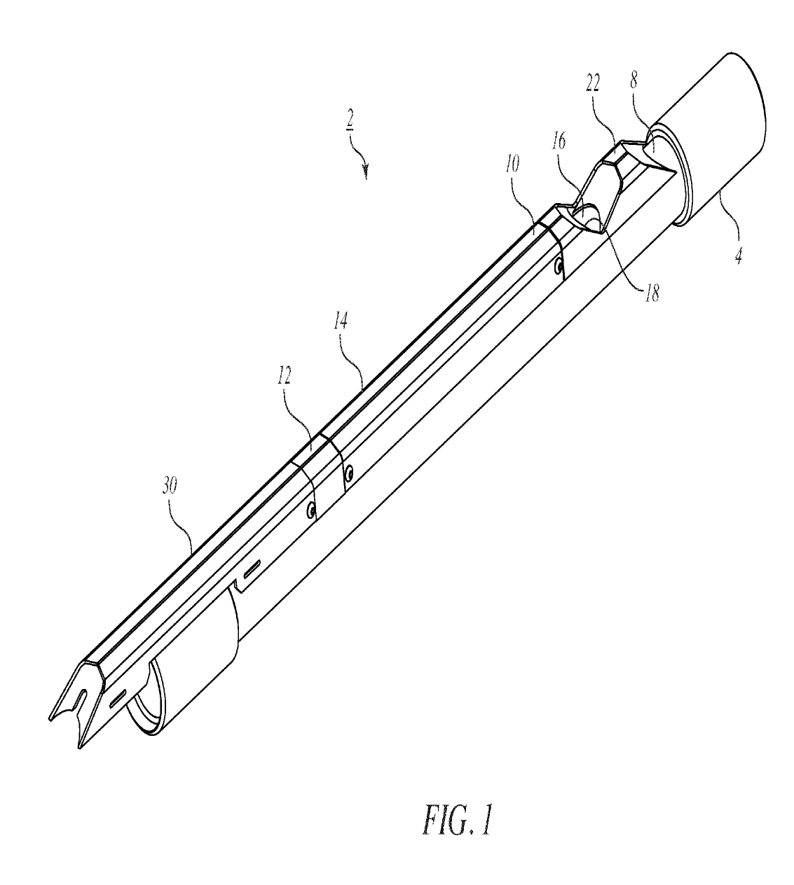

The present invention is directed to a float arrangement (or assembly) and/or a sensor arrangement (or assembly) for a pump jack-type well. Certain preferred and non-limiting embodiments or aspects of this float arrangement (or assembly) and/or sensor arrangement (or assembly) are shown and illustrated in FIGS. 1-5.

In certain preferred and non-limiting embodiments or aspects, the float arrangement (or assembly) and/or a sensor arrangement (or assembly) according to the present invention may include one or more of the following features and/or structural components:

Some or all of the components of the system are constructed of at least one of the following: stainless steel, 316 stainless steel, stainless alloy, Inconel, and/or Hastelloy, with the exception of the float, which may be of ABS construction, and a stainless steel head and the float bumper, which may be of ABS construction.

The float arrangement (or assembly) and/or sensor arrangement (or assembly) are fitted to the outer surface of a stainless steel tubing section, and sized, shaped, and/or configured to fit to standard riser tubing used in a pump jack-type well.

The float arrangement (or assembly) is configured to operate in the annulus between the tubing and the inner diameter of the well casing.

A plough forms part of the float housing to prevent damage occurring to the float arrangement (or assembly) and/or the sensor arrangement (or assembly), e.g., the sensor mechanism, during installation.

One or more components of the sensor arrangement (or assembly) is mounted in a housing fixed to the outer surface of the tubing, and at least partially shrouded by or contained in a removable cover, which provides sensor access.

A cable strain is fitted to the outer surface of the tubing above the head of the sensor arrangement (or assembly) for securing the cable at the top of the housing.

A removable cover for the sensor arrangement (or assembly) also acts as cable protector to protect the cable from damage during installation.

At least one screen is fitted to the lower end of the float housing to prevent ingress of debris that may foul or otherwise affect the float arrangement (or assembly) during operation. This at least one screen may be at least one of the following: a coarse screen, a stainless steel screen, a filtering material, a screening material, an alloy material, a cloth material, a sponge material, a glass material, a spun glass material, or any combination thereof.

A single 4 conductor cable is required to operate both sensors, and purpose built waterproof “Y” splices are used down-well to join the lower float sensor to the main cable run.

At least a portion of the float arrangement (or assembly) is configured with a concave back profile concentric to the tubing section in order to maximize float size and float buoyancy.

At least one component of the float arrangement (or assembly) is configured with a profile with total clearances between the tubing section and the float cover exceeding that of the screen hole sizes to prevent wedge from small fines that might pass through the screens.

The fluid inlet/outlet is placed within a protected section of the plow to thereby prevent possible blockage of the inlet, especially at the time of down-hole installation.

The fluid inlet/outlet is located beneath the float cavity to prevent entry of sands or fines that may be falling or sinking in the well fluids.

The inlet/outlet is positioned such that the fluid ingress is upward through the filtering screen and digress back downward through the screen to create a “flushing” for debris caught by the screen.

At least a portion of the float arrangement (or assembly) is configured with a rounded sensor target dome and/or with tapered ends to help prevent the buildup or layering of admitted sands and fines.

At least one component of the float arrangement (or assembly) is internally machined, fabricated, and/or constructed to produce a structure with “webs” in order to increase its ability to withstand more environment well pressure. Further, the internal cavities produced internally may be filled with Styrofoam or other light cellular material to increase crushing pressure rating.

The sensor arrangement (or assembly) may be retained in a housing bore with two fasteners and two mounting clips so they can be installed or removed without spinning or threading. This allows sensors to be pre-wired prior for the site and spooled in or out of the well as the production string is lowered or raised.

The float arrangement (or assembly) may be a pre-pressurized float arrangement (or assembly), which provides a higher pressure capability.

At least one component of the float arrangement (or assembly) may include or be in the form of a closed-cell foam-filled component, which provides a higher pressure capability.

At least one component, e.g., the sensor mount, of the sensor arrangement (or assembly) is fitted with a bumper (which may be machined from ABS) with clearances that interfere with the float physically touching or continuously bumping or bobbing against the sensor face.

Components or portions of the float arrangement (or assembly), the screens, the sensor arrangement (or assembly), and/or the cable strain are all easily accessible externally from the device. Therefore, a unit piped or connected into the production tubing string need not be dismantled for service.

The float arrangement (or assembly) may be a dual float arrangement that automatically switches the pump jack system “on” and “off” in relation to the fluid column in the well. Program code may be provided to prevent the system from short circuiting if fluid is present near the switch. The float arrangement (or assembly) may also be a single float arrangement including an external flow meter and a control device, such as but not limited to a pump down timer and/or processor.

In this manner, provided is a float arrangement (or assembly) and/or a sensor arrangement (or assembly) for use in connection with pump jack-type well.

FIG. 1 shows an apparatus for that controls a liquid level down-hole of a hydrocarbon producing well by monitoring the liquid level down-hole 2, for purpose of this description, the apparatus can also be called a liquid level controller. The apparatus 2 has down hole tubing 4 that is connected directly to the tubing within the well. On the outer surface 8 of the tubing 4 has a plow 22. The plow is adjacent to the caged support structure 10 which can be a housing 14. Sensor 12 is adjacent to housing 14 to allow contact with a float (not shown in FIG. 1 but see FIGS. 3, 4, and 6). Sensor shroud 30 then covers an upper portion of the tubing 4 and covers the wiring for the sensor 12.

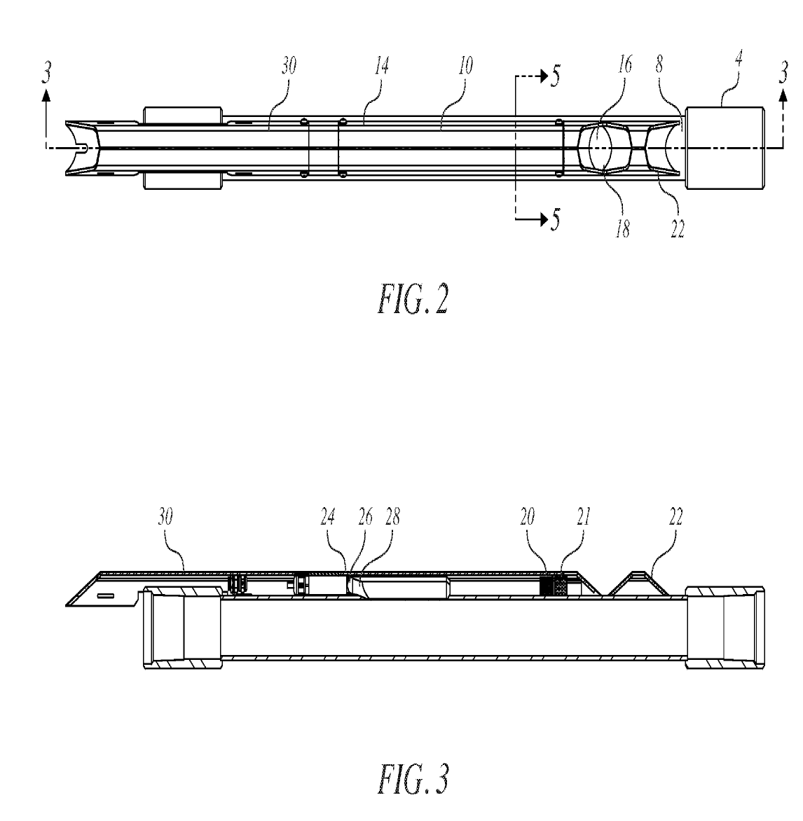

FIG. 2 shows a top view where inlet 16 and outlet 18 can be seen. In the exemplary embodiment shown both inlet 16 and outlet 18 are the same; however, they could be separate. FIG. 2 also shows the caged support structure 10, which is a housing 14. The plow 22 is connected to the outer surface 8 of the tubing 4. Sensor shroud 30 is adjacent to the out surface 8 of tubing 4.

FIG. 3 shows a section view along 3-3 of FIG. 2. A bumper is shown 24 along with a rounded sensor target dome 26 and tapered ends 28. Optionally prescreen 21 and screen can be used to prevent debris from filing the apparatus.

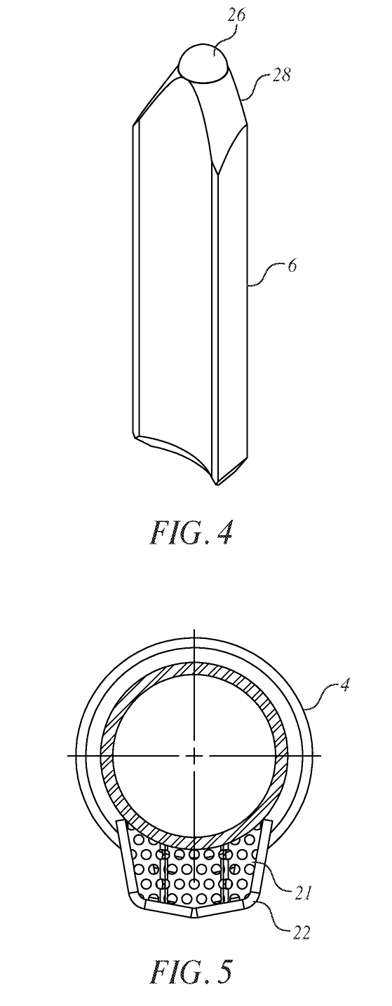

FIG. 4 shows an isometric view of float 6. Float 6 has a tapered ends 28 and a rounded sensor target dome 26.

FIG. 5 is cross section of FIG. 2 along the lines 5-5. Tubing 4 is shown as well as prescreen 21 and plow 22.

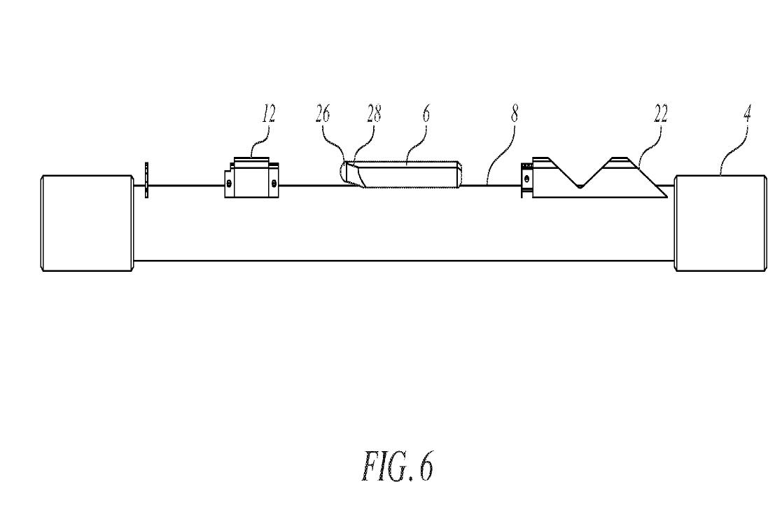

FIG. 6 is a side view without the housing or sensor shroud. Tube 4 is shown having plow 22 attached to the outer surface 8. Float 6 is also attached to the outer surface 8 of tubing 4. Float 6 has a rounded sensor target dome 26 and tapered ends 28. Float 6 floats until it reaches sensor 12.

Although the invention has been described in detail for the purpose of illustration based on what is currently considered to be the most practical and preferred embodiments or aspects, it is to be understood that such detail is solely for that purpose and that the invention is not limited to the disclosed embodiments or aspects, but, on the contrary, is intended to cover modifications and equivalent arrangements that are within the spirit and scope of the appended claims. For example, it is to be understood that the present invention contemplates that, to the extent possible, one or more features of any embodiment or aspect can be combined with one or more features of any other embodiment or aspect.

What is claimed is:

1. An apparatus that controls a liquid level down-hole of a hydrocarbon producing well by monitoring the liquid level down-hole in the well comprising:
(a) a down-hole liquid level measurer that is integral to and part of a down-hole tubing in the well; and
(b) a signal device connected to the liquid level measurer that causes a pump to adjust its current liquid output based on the liquid level down-hole as measured by the down-hole liquid level measurer.

2. An apparatus as recited in claim 1 wherein the down-hole liquid level measurer has a float within a caged support structure, the caged support structure is a unitary structure that both guides the float and protects it from touching a casing within the well and acts as a section of the down-hole tubing.

3. The apparatus as recited in claim 2 wherein the down-hole tubing is tubing for a pump jack-type well.

4. The apparatus as recited in claim 3 where the down hole liquid level measurer and tubing has a diameter small than 4.5 inches so that it can be used in in connection with a well that has having casing of 4.5 inches in diameter.

5. The apparatus as recited in claim 4 wherein the float is fitted to the outer surface of the tubing.

6. The apparatus as recited in claim 5 wherein the float is sized and shaped to fit to standard riser tubing used in a pump jack-type well.

7. The apparatus as recited in claim 4 wherein a sensor is fitted to the outer surface of the tubing, the sensor is located on the tubing so that it can sense the float.

8. The apparatus as recited in claim 7 wherein the cage structure is a float housing that covers the path of the float, the float housing having an inlet and outlet.

9. That apparatus as recited in claim 8 wherein the inlet and outlet of the float housing includes a screen to prevent debris from entering the float housing.

10. The apparatus as recited in claim 9 including a plow connected to the tubing to assist in installation and operation of the apparatus within the well.

11. The apparatus as recited in claim 10 wherein the float includes a bumper.

12. The apparatus as recited in claim 11 wherein the float includes a rounded sensor target dome and also has tapered ends.

13. The apparatus as recited in claim 9 including a sensor shroud.
